(19) United States
(12) Patent Application Publication
(10) Pub. No.: US 2013/0203886 A1
(43) Pub. Date: Aug. 8, 2013

(54) PROCESS FOR THE PRODUCTION OF AN UHMWPE ARTICLE

(71) Applicants: Nileshkumar Prakash Kukalyekar, Geleen (NL); Jan Stolk, Geleen (NL); Mitcha Sandor Nicolaas Mulders, Geleen (NL); Robert Hendrik Catharina Janssen, Geleen (NL); Harold Jan Smelt, Geleen (NL); Piotr Pawel Matloka, Geleen (NL)

(72) Inventors: Nileshkumar Prakash Kukalyekar, Geleen (NL); Jan Stolk, Geleen (NL); Mitcha Sandor Nicolaas Mulders, Geleen (NL); Robert Hendrik Catharina Janssen, Geleen (NL); Harold Jan Smelt, Geleen (NL); Piotr Pawel Matloka, Geleen (NL)

(21) Appl. No.: 13/582,813

(22) PCT Filed: Mar. 4, 2011
(86) PCT No.: PCT/EP11/53311

§ 371 Date: Nov. 12, 2012

Related U.S. Application Data
(60) Provisional application No. 61/310,965, filed on Mar. 5, 2010.

(30) Foreign Application Priority Data
Mar. 5, 2010 (EP) 10155588.6

(51) Int. Cl. C08F 236/20

(52) U.S. Cl. CPC C08F 236/20
USPC 522/158; 526/336

(57) ABSTRACT

The invention relates to a process for the production of an article, wherein—ethylene is polymerized with a polyene and optionally another comonomer, resulting in a polymer with a MFI (21.6) between 0.05 dg/min and 100 dg/min,—melt processing the polymer into an article,—optionally crosslinking the polymer during or after melt processing the polymer and—optionally sterilizing the polymer article by high energy irradiation.

The present invention relates to a process for the production of an UHMWPE article, to the article itself and to the use of the article in a medical application.

Ultrahigh molecular weight polyethylene (UHMWPE) is well known for, among other properties, its chemical resistance, low friction coefficient, fatigue and fracture resistance, high toughness and, in particular, its excellent resistance against wear. As a result it has found applications in the field of biomedical implants. These excellent properties have made UHMWPE the material of choice in orthopedics, especially in the fabrication of articular components for arthroplasty, for which a high wear resistance is required. The acetubular cup or liner in a total hip joint replacement and the tibial insert in a total knee joint replacement are important applications of UHMWPE.

Equally well-known, however, is the fact that UHMWPE is difficult to mold, which is due to the fact that UHMWPE, above its crystalline melting temperature, does not form a fluid phase that is of a viscosity that permits melt processing techniques used for molding many other thermoplastic polymers.

Due to this high viscosity UHMWPE is processed into shapes and objects using, for example, ram-extrusion, pre-forming and sintering of compressed powder, optionally followed by machining or skiving, high isostatic pressure processing, and the like. These methods are generally less economical than common melt-processing methods and severely limit the types and characteristics of objects and products that can be manufactured with UHMWPE.

UHMWPE can be obtained by any known process for the production of UHMWPE, as described by for example Steven M. Kurtz in “The UHMWPE Handbook”, Elsevier Academic Press, 2004, p. 14-22. UHMWPE is generally obtained as a powder which can further be processed by molding and machining as described hereabove.

Studies have shown that cross-linking of UHMWPE with gamma or electron beam rays is highly effective against wear, which was most clearly demonstrated for smooth counterfaces, such as those generally involved in a prosthetic coupling. However, increasing the molecular mass of UHMWPE by crosslinking has the disadvantage that it decreases other mechanical properties and oxidative resistance.

WO-09/060044 describes a process to produce UHMWPE articles out of ethylene-polyene copolymers and crosslinking of these polymers. Crosslinking of these copolymers can be performed at an irradiation dose between 10 and 40 kGy. This is a lower irradiation dose than normally applied for crosslinking of UHMWPE homopolymers, which is between 40 and 130 kGy. Crosslinking of ethylene-polyene copolymers at this lower irradiation dose gives polymer articles having wear properties that are comparable with or better than the wear properties of crosslinked UHMWPE homopolymers that are crosslinked at higher irradiation levels.

It has now surprisingly been discovered that polymers of ethylene, polyene and optionally another comonomer, having a MFI (21.6) between 0.05 dg/min and 100 dg/min, are melt-processable into articles.

Articles are produced by the following process, wherein
ethylene is polymerized with a polyene and optionally another comonomer, resulting in a polymer with a MFI (21.6) between 0.05 dg/min and 100 dg/min,
melt processing the polymer into an article,
optionally crosslinking the polymer during or after melt processing the polymer and
optionally sterilizing the polymer article by high energy irradiation.

Advantages producing an article by melt-processing are that: it is possible to make more complex article forms and that the use of machining to make final articles out of molded UHMWPE is superfluous.

Another advantage of this process is that a final article which is sterilized and ready to be used as an implant can now be obtained in only two production steps; a) melt-processing the UHMWPE into a final article form and b) crosslinking and sterilization of the final article at an irradiation dose below 40 kGy.

Starting from homopolymer UHMWPE four production steps are necessary; a) compression molding an UHMWPE stock shape, b) crosslinking of the UHMWPE in the stock shape at an irradiation dose above 40 kGy, c) machining the article out of the UHMWPE and d) sterilization of the article at an irradiation dose below 40 kGy.

A major benefit of the use of irradiation levels below 40 kGy is that the number of remaining free radicals after crosslinking is reduced considerably, as the number of free radicals scales with the irradiation dose. This leads to improved oxidation resistance for the crosslinked copolymer materials.

The polymer is formed from ethylene, a polyene and optionally other comonomers.

Polyenes are linear, branched or cyclic polyenes having 3-100 carbon atoms preferably with 3-50 carbon atoms and more preferably with 3-20 carbon atoms. The polyene used in the present invention is a hydrocarbon compound having in the molecule at least two unsaturated bonds, preferably double bonds. For example, there can be mentioned diene type hydrocarbon compounds such as 1,2-propadiene, 1,3-butadiene, 1,3-pentadiene, 1,4-pentadiene, 1,4-hexadiene, 2,4-hexadiene, 1,5-hexadiene, 1,6-heptadiene, 1,7-octadiene, 2,3-dimethyl-1,3-butadiene, 2-methyl-1,3-butadiene, 2-methyl-2,4-pentadiene, 3-methyl-2,4-hexadiene, 2,5-dimethyl-1,5-hexadiene, 4-methyl-1,4-hexadiene, 5-methyl-1,4-hexadiene, 4-ethyl-1,4-hexadiene, 4,5-dimethyl-1,4-hexadiene, cyclohexadiene, 4-methyl-1,4-heptadiene, 4-ethyl-1,4-heptadiene, 5-methyl-1,4-heptadiene, 4-ethyl-1,4-octadiene, 5-methyl-1,4-octadiene and 4-n-propyl-1,4-decadiene, polyolefin type hydrocarbon compounds such as 1,3,5-hexatriene, 1,3,5,7-octatetraene and 2-vinyl-1,3-butadiene, squalene, divinylbenzene, vinylnorbornene, ethylene norbomene and dicyclopentadiene.

Preferably a diene type hydrocarbon compound is used as the polyene. Among them, linear diene type hydrocarbon compounds that polymerize very well with ethylene are preferred.

The polyenes can also contain hetero atoms, such as, for example, oxygen, sulfur, nitrogen, phosphor, silicon, chlorine, bromine or fluorine atoms.

The determination of the polyene content can be done by using an infrared spectrophotometer. The absorbances at 880, 910 and 965 cm⁼¹, which indicated the double bonds in the polyene structure included in the ethylene chain, are measured, and the measured values are converted to the number of the unsaturations per 100,000 carbon atoms by using a calibration curve prepared in advance by using a model compound in ¹³C nuclear magnetic resonance spectroscopy. The sum of the converted values of the peaks, which differ according to the structure of the introduced polyene, indicates the total polyene content. Alternatively, ¹H and/or ¹³C-NMR can be applied to determine the content of unsaturations.

The polyene comonomer is preferably used in such an amount that the amount of unsaturations in the polymer is between 1 and 1500 per 100,000 carbon atoms. If the amount of unsaturations is smaller than 1 per 100,000 carbon atoms a structure effective for improving the wear resistance cannot be formed. On the contrary, if the amount of unsaturations exceeds 1500 per 100,000 carbon atoms, the crystallinity is drastically reduced. Preferably the polyene comonomer should be used in such an amount that the amount of unsaturations per 100,000 carbon atoms in the polymer chain is between 5 and 500, more preferably between 10 and 50 unsaturations per 100,000 carbon atoms.

Examples of other comonomers used are alpha-olefins containing 3-20 carbon atoms such as propylene, 1-butene, 1-pentene, 4-methyl-1-pentene, 1-hexene, 1-octene, 4,6-dimethyl-1-heptene, 1-decene, 1-tetradecene, 1-hexadecene, 1-octadecene, 1-eicosene, allylcyclohexane, and the like.

The other comonomer can also contain hetero atoms, such as, for example, oxygen, sulfur, nitrogen, phosphor, silicon, chlorine, bromine or fluorine atoms.

Examples are tetrafluoroethylene, chlorotrifluoroethylene, alkenecarboxylic acids, carbon monoxide, vinyl acetate, vinyl alcohol, alkyl acrylates, such as methyl acrylate, ethyl acrylate, butyl acrylate, and the like, or mixtures thereof.

Preferably, the amount of such comonomer is less than about 10 mol %, for instance less than about 5 mol % or less than about 3 mol %. Accordingly, the amount of comonomer on a weight basis may be less than about 10 wt %, for instance less than about 5 wt %, such as in the range of 0.5-5 wt %.

The polymer can be obtained by any known process for the production of UHMWPE or HMWPE, for example, by slurry-polymerizing ethylene, polyene and optionally another comonomer in an organic suspension agent in the presence of a catalyst comprising a transition metal of the group IVb, Vb, VIb or VIII of the Periodic Table, a halide of a metal of the group I, II or III of the Periodic Table or an organic metal compound, using such a content of polyene that the number of polyene branches is 1 to 1500 on the average per 100,000 carbon atoms. In particular a Ziegler-Natta catalyst made of titanium chloride, optionally on a support, for example MgCl₂ or SiO₂/MgCl₂, and organo-aluminum compounds, e.g. triethyl-aluminum or diethyl aluminum chloride, is used. Alternatively a metallocene catalyst may be used, as described in for example EP-1605000A1. Because these chemicals are very sensitive to air and moisture, all the steps in the synthesis are carried out in an inert gas environment. Polymerization generally takes place at a temperature of between 55 and 90° C. under a pressure of between 1 and 40 bar. The molecular weight of the polymer can be controlled by adding very small amounts of hydrogen to the ethylene gas or by changing the polymerization temperature, the pressure or the amount of organo-aluminum compound. After the polymerization, the polymer particles are separated from the suspension agent and dried. In particular, most of the suspension agent is separated via centrifugation, and the remaining suspension agent is removed by drying, for example in a stirred bed dryer or a fluid bed dryer. As a suspension agent medium boiling aliphatic solvents can be used, for example hexane or heptane. The boiling point of said suspension agent is preferably higher than the reaction temperature but not too high to avoid problems when removing the suspension agent.

The polymer formed is a high molecular weight polymer (HMWPE) or an ultra high molecular weight polymer (UHMWPE).

HMWPE is a substantially linear ethylene polymer having a MFI (21.6) between 0.05 and 10 dg/min, more preferably between 0.05 and 8 dg/min, most preferably between 0.05 and 5 dg/min. The MFI is determined according to ISO 1133-91.

The HMWPE has a weight average molecular weight (Mw) of 3.10⁵ g/mol or more and a molecular weight distribution (M_{w}/Mₙ) of between 2 and 18, more preferably between 2 and 10.

UHMWPE is a substantially linear ethylene polymer having a MFI (21.6) of 0.01 dg/min or more, preferably between 0.01 and 0.05 dg/min. The UHMWPE has a weight average molecular weight (Mw) of 1.10⁶ g/mol or more and a molecular weight distribution (M_{w}/Mₙ) of between 2 and 18, more preferably between 2 and 10.

Processing of the polymer into an article is performed by using melt-processing methods used for thermoplastic polymers that are known to the men skilled in the art. Typical examples of such methods are granulation, pelletizing, (melt-) compounding, melt-blending, injection molding, transfer-molding, melt-blowing, melt-compression molding, melt-extrusion, melt-casting, melt-spinning, blow-molding, melt-coating, melt-adhesion, welding, melt-rotation molding, dipblow-molding, melt-impregnation, extrusion blow-molding, melt-roll coating, embossing, vacuum forming, melt-coextrusion, foaming, calendering, rolling, and the like.

Melt-processing of the polymers according to the present invention, in its most general form, often comprises heating the composition to above the crystalline melting temperature of the polymers to yield a polymer fluid phase. The crystalline melting temperatures of the polymers are typically in the range from 100° C. to 145° C., although somewhat lower and higher temperatures may occur, The melt is shaped through common means into the desired form and, subsequently or simultaneously, cooled to a temperature below the crystalline melting temperature of the polymers, yielding an object or article having good mechanical properties and a high resistance against wear.

Processing can, of course, also be performed by compression molding, wherein a mold filled with polymer is subjected to a combination of high temperature and high pressure for a certain amount of time. Subsequently the system is cooled at a slow and uniform rate in order to minimize shrinkage and deformation, and optimize the crystallinity and the mechanical properties of the product. The product is thereafter machined into smaller blocks or cylindrical bars from which the final components can be machined.

Methods that are used for cross-linking, and which can also be applied to the article comprising the polymer according to the invention, are high energy irradiation by electromagnetic irradiation and chemical-induced cross-linking, as described, for example, by G. Lewis in Biomaterials 2001, 22: 371-401. Examples of high energy electromagnetic irradiation are beta and gamma irradiation and electron beam irradiation

With gamma irradiation or electron beam irradiation the irradiation dose used to obtain a highly cross-linked article is chosen between 10 and 250 kGray (kGy), preferably between 10 and 130 kGy, more preferably between 10 and 80 kGy and most preferably between 10 and 40 kGy. To obtain a lower cross-linked article or when irradiation is used in combination with chemical cross-linking by the use of an initiator, a low irradiation dose can be used, from for instance 10 to 40 kGy.

For sterilization of the article according to the invention an irradiation dose between 10 and 40 kGy, can be used.

The article comprising the polymer according to the invention may be sterilized applying for example gamma sterilization in air or, preferably, in an inert atmosphere, using an irradiation dose of between 10 and 40 kGy, preferably between 20 and 35 kGy. Also, gas plasma sterilization or ethylene oxide gas sterilization, as described in the above-referenced “The UHMWPE Handbook” on p. 37-47 can be used.

Preferably, crosslinking by irradiation after melt processing of the polymer is combined with sterilization of the article during the same irradiation step.

According to a second embodiment of the invention the polymer is cross-linked by adding an initiator, for example a peroxide, and optionally a coagent to the polymer. Optionally a coagent, a compound with 2 or more unsaturations, is used to enhance the peroxide cross-linking efficiency. Examples of suitable peroxides include tert-butyl cumyl peroxide, tert-butyl peroxybenzoate, di-tert-butyl peroxide, 3,3,5,7,7-pentamethyl-1,2,4-trioxepane,1,1-di(tert-butylperoxy)-3,3,5-trimethylcyclohexane, butyl 4,4-di(tert-butylperoxy)valerate, 2,5-dimethyl-2,5-di(tert-butylperoxy)hexyne-3,2,5-dimethyl-2,5-di(tert-butylperoxy)hexane, di(4-methylbenzoyl) peroxide, dibenzoyl peroxide, di(2,4-dichlorobenzoyl) peroxide, dicumyl peroxide, 3,3,5,7,7-pentamethyl-1,2,4-trioxepane, 1-(2-tert.-butylperoxyisopropyl)-3-isopropenyl benzene, 2,4-diallyloxy-6-tert-butylperoxy-1,3,5-triazine, di(tert-butylperoxyisopropyl)benzene, diisopropylbenzene monohydroperoxide, cumyl hydroperoxide, and tert-butyl hydroperoxide.

Examples of suitable coagents include divinylbenzene, diallylphthalate, triallylcyanurate, triallylisocyanuarate, triallyltrimellitate, meta-phenylene bismaelimide, ethyleneglycol dimethacrylate, ethyleneglycol diacrylate, trimethylopropane timethacrylate, trimethylopropane, timethacrylate, pentaerytritol tetramethacrylate, zinc diacrylate, zinc dimethacrylate, and polybutadiene. These peroxides and coagents, either as liquid or powder, can be mixed with the polymer powder, and then molded. Whereas when irradiation is used cross-linking occurs in the solid state of the polymer, peroxide cross-linking occurs in the melt.

Preferably, crosslinking of the polymer is performed by high energy irradiation. More preferably, crosslinking is performed with an irradiation dose between 10 and 40 kGy.

The crosslinked polymer preferably has a wear factor lower than 2.0 10⁻⁶ mm³/Nm after irradiation.

The crosslinked polymer preferably has a yield stress between 15 and 50 MPa.

Furthermore, the polymer can contain non-polymer materials such as additives, solvents and fillers. In particular, anti-oxidants, such as vitamin E and Hindered Amine Light Stabilizers (HALS) may be added to avoid excessive oxidation during cross-linking, sterilization or use. A much lower amount of a HALS stabilizer can be used compared with the amount of vitamin E. The HALS stabilizer is preferably used in an amount of between 0.001 and 5% by weight, more preferably between 0.01 and 2% by weight, most preferably between 0.02 and 1% by weight, based on the total weight of the polymer. Preferably, the HALS stabilizer chosen is a compound derived from a substituted piperidine compound, in particular any compound which is derived from an alkyl-substituted piperidyl, piperidinyl or piperazinone compound or a substituted alkoxypiperidinyl compound.

The invention is further directed to an article obtainable by the process according to the invention. The article can be applied in a wide variety of applications, for example in medical applications, such as in orthopedics as bearing material in artificial joints. Preferably, the article is an artificial medical implant.

The artificial medical implant can be used for hip arthroplasty, for example as acetubular cup or liner in a total hip joint replacement, knee replacement, for example as the tibial insert in a total knee joint replacement, shoulder replacement or spinal applications such as total disc replacement.

These applications are described in detail in the above-referenced “The UHMWPE Handbook” in Chapters 4-6 (hip), 7-8 (knee), 9 (shoulder) and 10 (spinal applications). Preferably, the artificial medical implant is a total joint replacement.

The present invention will now be described in detail with reference to the following examples that by no means limit the scope of the invention.

### EXAMPLES

### Materials:

### Catalyst;

Ti-containing Ziegler-Natta catalyst
Triethylaluminium (TEA); Chemtura

### Diene:

1,7-Octadiene; Aldrich 98%

### Examples 1 and 2 and Comparative Experiments A and B

### Preparation of ethylene-1,7-octadiene copolymers and the Characterization Thereof

### Polymerization Conditions:

Polymerizations were performed in a 10.0 L SS autoclave.
Polymerization temperature: 70° C., Monomer pressure: 0.5 MPa
Diene amount: 100 ml
Scavenger: TEA 10 mmol
Hydrogen: 6 nl

### Polymerization Procedure

The batch polymerization was performed in a 10.0 L batch autoclave equipped with a mechanical stirrer. The reaction temperature was set to 70° C. and controlled by a thermostat. The feed streams (solvent and ethylene) were purified by various absorption media to remove catalyst killing impurities such as water, oxygen and polar compounds as is known to someone skilled in the art. During polymerization ethylene was continuously fed to the gas cap of the reactor. The pressure of the reactor was kept constant at 0.5 MPa by a back-pressure valve.

In an inert atmosphere the previously dried reactor was filled with 4000 mL heptane. After the solvent had reached the desired temperature, the second monomer (diene), hydrogen, the catalyst and TEA were added. Ethylene was added to a maximum pressure of 0.5 MPa. After the desired polymerization time, the contents of the reactor were collected, filtered and washed with 9 L heptane to remove the unreacted diene. After drying under vacuum at 50° C. overnight, the polymer was weighed and samples were prepared for analysis.

Polymer powder was compression molded into test samples according to ISO-11542. Irradiation of the test samples was performed by gamma irradiation on samples that were vacuum sealed into paper bags with an aluminum coating on the inside.

To prepare the test samples for the swell test and the wear test a stock sample was prepared that was later machined into the small test samples needed for those tests. The small test samples were irradiated.

### Amount of Double Bonds

The amount of double bonds per 100,000 carbon atoms was determined by using an infrared spectrophotometer. The absorbances at 880, 910 and 965 cm⁻¹, which indicate the double bonds in the polyene structure included in the ethylene chain, were measured, and the measured values were converted to the number of the unsaturations per 100,000 carbon atoms by using a calibration curve prepared in advance by using a model compound in ¹³C nuclear magnetic resonance spectroscopy. The sum of the converted values of the peaks, which differed according to the structure of the introduced polyene, indicated the total polyene content.

### Wear Test

Pins with a diameter of 9 mm and a length of 12 mm were machined from the irradiated stock sample.

The wear test was performed in a Weartester SuperCTPOD TE87. In the weartester 100 pins could be evaluated at once. The pins were moved in the tester with a circular motion.

The pins were tested for a total distance of 18 km at 1 Hz cycle frequency in HyClone Alpha Calf serum (from Thermofischer Scientific) that was diluted with ultra-pure water (1:1). The serum was used for lubrication and the pins were moved in the weartester against polished CoCr disks using 1.1 MPa nominal contact pressure and 31.4 mm/s sliding speed. To retard the harmful degradation of the lubricant, its temperature was kept at 20±0.5° C. At intervals of 6 km, the test was stopped, and the specimens and their holders were dismantled and cleaned. The pins were vacuum desiccated, allowed to stabilize in room atmosphere for at least 2 hours and then weighed, after which the system was reassembled, and the test was continued with fresh lubricant. For all samples, a soak control pin was used to see if the materials showed considerable weight gain due to fluid absorption.

The wear factor was determined using the formulae below:

$${Wear}_{y} = {\{ ( {m}_{{pin}_{run ( x )}} - {m}_{{pin}_{run ( 0 )}} ) + ( {m}_{{pin}_{soak ( x )}} - {m}_{{pin}_{soak ( 0 )}} ) \}}_{{pin}_{y}} -> [ mg ]$$

$$x = [ 1 , 2 , 3 ] -> number \cdot of \cdot run$$

$$y = [ 1 , 2 , 3 , 4 , 5 ] -> number \cdot pin \cdot per \cdot material$$

$${Wearfactor}_{y} = 1000 \cdot \{ ( \frac{{wear}_{y}}{ρ} ) / ( F \cdot {s}_{{run}_{x}} ) \} -> [ {10}^{- 6} {mm}^{3} \text{/} Nm ]$$

$$x = [ 1 , 2 , 3 ] -> number \cdot of \cdot run$$

$$y = [ 1 , 2 , 3 , 4 , 5 ] -> number \cdot pin \cdot per \cdot material$$

$$F = Load \cdot on \cdot pins -> [ N ]$$

$$s = Distance \cdot per \cdot run -> [ m ]$$

$$ρ = Density \cdot of \cdot material -> [ \frac{mg}{{mm}^{3}} ]$$

The value given in Table I was the average value of 5 samples.

### Hysteresis Test

The hysteresis test was performed by cyclic loading in tensile up to a stress of 20 MPa at a frequency of 0.5 Hz at room temperature. The minimal stress was 0.5 MPa. The test used ISO 527 Type 5B test bars with a length of the narrow section of 12 mm. The value for the ultimate tensile stress (UTS) is given in Tables I and II

### Yield Stress and EAB

The yield stress and EAB are determined according to ISO 527 Type with 5B test bars.

The yield stress, and the elongation at break (EAB) results are given in Tables I and II.

### Crystallinity

The crystallinity was determined from DSC measurements: 0-200° C. at 10K/min. The crystallinity=(ΔHₘ/291)*100. ΔHₘ (J/g) was taken from first heating curve.

### MFI

The MFI (21.6) was determined according to ISO 1133-91.

TABLE I

| | | | | Unsaturations | | Gamma | | Yield | | |
|---|---|---|---|---|---|---|---|---|---|---|
| | | Yield | MFI(21.6) | (amount per | Crystallinity | dose | Wear factor | stress | UTS | EAB |
| Example | Polyene | (g) | (dg/min) | 100,000 C) | (%) | (kGy) | (10⁻⁶ mm³/Nm) | (MPa) | (MPa) | (%) |
| A a | — | 1770 | 0.3 | 4 | 72 | 0 | 2.80 | 29 | 58 | 822 |
| A b | | | | | | 25 | 1.82 | | | |
| A c | | | | | | 75 | 0.70 | | | |
| 1 a | 1,7- | 1770 | 0.1 | 21 | 65 | 0 | 2.03 | 24 | 56 | 759 |
| | octadiene | | | | | | | | | |
| 1 b | | | | | | 25 | 0.64 | | | |
| 1 c | | | | | | 75 | 0.31 | | | |
| B a | — | 1450 | 2.0 | 2 | 77 | 0 | 3.37 | 31 | 42 | 754 |
| B b | | | | | | 25 | 2.26 | 31 | 42 | 669 |
| B c | | | | | | 75 | 1.16 | 32 | 42 | 441 |
| 2 a | 1,7- | 1402 | 0.2 | 21 | 73 | 0 | 2.88 | 28 | 47 | 820 |
| | octadiene | | | | | | | | | |
| 2 b | | | | | | 25 | 0.25 | 28 | 47 | 496 |
| 2 c | | | | | | 75 | 0.05 | 29 | 48 | 376 |

From the results in Table I it follows that the irradiated samples out of examples 1 and 2 show a significantly lower wear than the irradiated samples according to the comparative experiments A and B.

With a low amount of irradiation a low amount of wear data can be obtained, which is advantageous to reduce the oxidative degradation of the polymer.

The crystallinity of the polymer in the examples 1 and 2 is high, which is an indication for mechanical properties comparable with UHMWPE. This is confirmed by the yield stress and UTS results.

### Examples Injection Molding

The polymer of Example 2a with an MFI (21.6) of 0.2 dg/min (Mw=420 kg/mol, Mn=76 kg/mol) was injection molded into test bars (size 2×21×50 mm) on a mini injection molding machine (DSM Xplore Injection Moulding Machine (5.5 mL, part nr. 98024)).

The melt was produced by filling the chamber with 3.5 g of polymer powder. Thereafter the polymer powder was allowed to melt completely in about 15 minutes. The temperature of the polymer melt was 200° C. The test bars were molded from the molted polymer melt. The injection pressure was 6 bar. The size of the nozzle was 1.5 mm. The temperature of the mold and the cooling method of the mold were varied according to Table II.

The yield stress and the elongation at break (EAB) of the test bars were determined by the methods discussed above.

TABLE II

| | Temperature | Cooling | Yield Stress | EAB |
|---|---|---|---|---|
| Example | Mold, ° C. | Method | MPa | % |
| 3 | 120 | Quenched* | 23 | 171 |
| 4 | 160 | Quenched* | 23 | 700 |
| 5 | 120 | Open mold** | 22 | 80 |
| 6 | 130 | Open mold** | 22 | 120 |
| 7 | 140 | Open mold** | 22 | 250 |
| 8 | 160 | Open mold** | 22 | 700 |
| 9 | 120 | Anneal*** | 28 | 160 |

*Quenched: remove mold and test bar as soon as possible.
**Open mold: open the mold and remove test bar as soon as it is crystallized.
***Leave the test bar in the mold and anneal at 110° C. for 2 hours.

1-14. (canceled)

15. A process for the production of an artificial medical implant, comprising the steps of
polymerizing ethylene with a polyene and optionally another comonomer, resulting in a polymer with a MFI (21.6) between 0.05 dg/min and 100 dg/min,
melt processing the polymer into an article, and
crosslinking and sterilizing the polymer by high energy irradiation after melt processing the polymer into an article, wherein crosslinking and sterilizing the polymer is combined during the same irradiation step.

16. The process of claim 15, wherein the irradiation dose for crosslinking and sterilization is between 10 and 40 kGy.

17. The process of claim 15, wherein the polyene is a diene.

18. The process of claim 17, wherein the diene is a linear diene.

19. The process of claim 15, wherein the amount of unsaturations in the polymer is between 1 and 1500 per 100,000 carbon atoms.

20. The process of claim 15, wherein the crosslinked polymer has a wear factor lower than 2.0 10⁶ mm³/Nm.

21. The process according to claim 15, wherein the yield stress of the crosslinked polymer is between 15 and 50 MPa.

22. The process of claim 15 wherein the high energy irradiation is gamma irradiation.

23. An artificial medical implant made by the process of claim 15.

24. The artificial medical implant of claim 23, wherein the artificial medical implant is a total joint replacement.
